(19) United States
(12) Patent Application Publication
(10) Pub. No.: US 2003/0040899 A1
(43) Pub. Date: Feb. 27, 2003

(54) Tools and techniques for reader-guided incremental immersion in a foreign language text

(76) Inventor: John W.L. Ogilvie, Salt Lake City, UT (US)

Correspondence Address: JOHN W L OGILVIE, COMPUTER LAW, 1211 EAST YALE AVE, SALT LAKE CITY, UT, 84105, US

(21) Appl. No.: 09/948,354

(22) Filed: Sep. 8, 2001

Related U.S. Application Data
(60) Provisional application No. 60/311,892, filed on Aug. 13, 2001.

(51) Int. Cl. G06F 17/28

(52) U.S. Cl. 704/2

(57) ABSTRACT

An aid for improving language skills permits readers of a book or other work to incrementally display a translation of the work. In one embodiment, the work is initially displayed (902) on a device (100) in a first language. The user selects (1004) part of the displayed text. The selection, which identifies a linguistic unit having counterparts in at least two languages, is interpreted as a translation request. The device therefore obtains (906) a translation of the selected text and displays (908) it. By leaving the translation on display, the user indicates (1008) a preference for the translation rather than the original text. This preference is noted (910) in a data structure. As a result, the reader will subsequently see (1010) the translation rather than the original text when another instance of the translated linguistic unit is encountered after the reader continues reading.

### RELATED APPLICATIONS

This application claims priority to commonly owned copending application Ser. No. 60/311,892 filed Aug. 13, 2001, which is incorporated herein by reference.

### FIELD OF THE INVENTION

The present invention relates generally to language education and entertainment, and in particular relates to incremental immersion in translations of text between two or more languages or notations.

### TECHNICAL BACKGROUND OF THE INVENTION

Foreign languages are fascinating, and even a limited knowledge of another language can be very helpful. However, learning a new language can be very difficult, especially for adults. As a result, many methods and systems have been devised to help people improve their ability to understand and use various languages.

Many existing language learning aids are mainly or entirely paper-based. These include, for instance, dictionaries printed on paper, grammar textbooks, workbooks, phrasebooks for travelers, translations printed on paper, and introductory or other “readers” printed on paper. Such paper learning aids have been widely used and can be extremely useful.

However, conventional paper learning aids do not take advantage of some capabilities that can be provided by a computerized device. As a result, they do not provide some of the capabilities that are present in one or more embodiments of the present invention. Some of the computer-based capabilities that can be provided by the present invention include: visually replacing a word or phrase with its translation; recording the occurrence of that replacement, so that other instances of the replaced word or phrase can be replaced by their translation without further reader effort; speaking a word or phrase out loud to aid pronunciation; animating movement of words or characters to illustrate differences in sentence order between two languages; and animating the drawing of Chinese or other oriental characters to illustrate stroke order. At least two of these capabilities—speaking a word or phrase out loud to aid pronunciation, and animating characters to show stroke order—are apparently also provided by computerized devices that precede the invention.

U.S. Pat. No. 5,178,542 describes a non-computerized learning aid which allows a reader to become accustomed to full phrase translation, as opposed to word-by-word translation. Text and graphics are provided on a page. A transparent overlay contains a translation of the page text, positioned on the overlay on an opaque background in register with the wording translated. When the overlay is lifted, the reader sees only the text in its original foreign-language version. When the overlay is laid down on top of the page, the page text is blocked by the overlaid text; the artwork is still visible through the overlay. Although this learning aid replaces text in one language with text in another language, it does not respond to that replacement by automatically also replacing other instances of the replaced phrase with a translation.

Some previously known computer technologies focus on obtaining a translation of blocks of text that are supplied by the user. For instance, substantial work has been devoted to “machine translation” which performs automatic translation between natural languages. Machine translation systems and methods are in use and available to the public, e.g., on the Internet at the babelfish.altavista.com site. Machine translation systems and methods can be very helpful resources. However, the “babelfish” site technology apparently does not provide initial texts to users; instead, it expects users to provide a text in one language for translation into another language. Apparently it does not distinguish between users, much less “remember” whether a given user has previously translated a given word or phrase into a particular language. It simply accepts as input a text and a request to translate the text from one specified language to another specified language, and then provides a suggested translation of the text. Words unknown to the “babelfish” machine translation system are not translated (partial translations may therefore be displayed when translation fails), but in general all the words given as input are translated to produce the output, in what appears to the user as a single translation step.

Unlike an embodiment of the present invention, the “babelfish” site technology does not provide incremental immersion. To provide incremental immersion, the invention's embodiment presents a text to a reader and then lets the reader iteratively select and translate (or untranslate) words, showing the words translated in context in sentences. The context shown is generally a partial translation, with some words of a sentence translated and others not translated. That is, the displayed text often appears in two (or more) languages. The reader is incrementally immersed in a translation as more and more words and phrases are translated and displayed by the invention in response to reader requests. The embodiment remembers which words the reader has translated, and displays the translation of each word in context when the word is used anywhere in the presented text. This is not done at the “babelfish” site.

Similarly, computerized dictionaries and computerized verb conjugators can be very helpful, but they are not substitutes for the present invention because they do not provide incremental immersion in a magazine, journal, novel, poem, or other cohesive text of primary interest to a reader. Although they can help the reader understand such primary texts, they are generally separate from those texts. Unlike novels and other cohesive literary works that the reader wants to understand, dictionaries and other references are not usually read for their own sake. As a result, separate references necessarily take the reader from the text of primary interest to another context—outside the primary text—to look up a translation for a given word or phrase of the primary text, or to resolve some question of grammar arising from the reader's traversal of the primary text. Unlike embodiments of the invention, dictionaries and other external aids do not modify the displayed initial instance of the word or phrase in context in the primary text to reflect the reader's new knowledge, and they do not modify later instances of the word or phrase in the primary text. The reader is forced to jump between the primary text and the reference, and the reader does not receive the visual feedback that is given by the invention when a user-selected word or phrase is shown in translation in context in the primary text.

At least one computerized language course does integrate a dictionary with a prose text in another language, namely, the Spanish language course “Tesoros” published by McGraw-Hill (see, e.g., FIG. 2 in http://astro.temple.edu/˜jburston/CALICO/review/tesoros.htm). Holding the mouse cursor over a word displayed in red by the program will reveal a “gloss” (translation) supported by a drawing. The text is supplemented, not replaced. Not every word in the text has a gloss, so much of the text can be displayed in only one language. Moreover, it is apparently not asserted that the “Tesoros” program responds to the user's request for translation of a given word by translating other instances of that word without further prompting by the user.

Many other computerized language-learning systems and courses have also been developed. Many such courses take advantage of computer capabilities by providing features such as playing video or audio clips, speaking synthesized speech, rendering images of real-world or imaginary environments, accepting user speech via a microphone and analyzing it with speech recognition software to test the user's pronunciation, displaying text, displaying subtitles or other translations, displaying animated models of a speaker's mouth to aid pronunciation, parsing sentences into constituent phrases and words, conversing, posing questions (true/false, multiple choice, fill-in-the-blank, scrambled sentences to be placed in correct word order, and/or otherwise) to a user and grading the answers, providing games (including language games based on “Bingo”, “Concentration”, solving a mystery, and other games), visually annotating displayed text, tracking user progress through a set of lessons or exercises, and providing links to email or websites. However, previously known approaches apparently do not teach the incremental immersion tools and techniques of the present invention.

U.S. Pat. No. 5,649,826 discusses a media series comprising audiovisual material which can be electronically stored and adapted for use on a computer. The media series preferably comprises a foreign language to be learned and the user's “native” language. The media series is made up of a plurality of series levels or lessons, which sequentially contain an increasing percentage of the foreign language. Throughout each series lesson, it is preferred that the foreign language be strategically used so that the context within which the foreign language is used makes the translation and meaning of the foreign language obvious and intuitive. Successive series lessons can include foreign words already used in a previous series lesson plus additional foreign words. A student may click on illustrated objects to obtain a foreign language name or phrase of the object. However, it is not asserted that the program will remember that the student requested a particular translation. A student may also be able to select the percentage of a foreign language to be included within a given series lesson. However, the selection of which words or phrases are translated to obtain the specified percentage for the series lesson in question is apparently made by the series lesson author and/or by a computer program, not by the student who is using the program.

Chapter 13 of Advanced C Struct Programming, by John W. L. Ogilvie, inventor of the present invention, says little or nothing about foreign languages. But foreign language courses often discuss grammar, and this reference does describe the design and implementation of a simple game that reinforces grammar terminology in English. Play starts with a sentence template, and a set of words that can be used to complete it. The template is a sentence in which some words have been replaced by grammatical terms, such as “A <adjective> <noun> <adverb> <verb> that my <noun> is <adjective>!”. The game's object is to fill in the template in a way that is grammatically correct but semantically silly. For instance, the template might be filled in to produce “A blue monkey quickly sings that my jaguar is fresh!” or “A fresh monkey quietly sings that my monkey is blue!”. Unlike the present invention, which permits a reader to view an incremental translation of a sentence in one language into a sentence in another language, the Chapter 13 grammar game involves incremental transformation of a sentence template in English into a sentence in English.

Thus, it would be an advancement to provide new tools and techniques for helping people read foreign languages by allowing a reader to incrementally display translations of portions of a text which are chosen by the reader, and by displaying partial translations that reflect the reader's specific progress in learning another language as described here. Such tools and techniques are described and claimed herein.

### BRIEF SUMMARY OF THE INVENTION

The invention provides tools and techniques for helping readers improve their language skills through a process of incremental immersion in a translation of a book, article, or other literary work. The reader selects the increments (words, oriental characters, phrases, equations, idioms, and so on) to be translated, and the order in which they are translated. The resulting partial translations are displayed on a computer screen, so the reader watches as the work is translated piece-by-piece. Thus, the reader guides an incremental immersion in a translation of the work. The invention keeps track of each individual translation requested by the reader, and when a previously translated text portion is encountered again, it is displayed in translated form without forcing the reader to repeat the translation request for each new instance of the previously translated text.

The invention is not a translation tool or translation technique per se, since it uses a pre-existing translation of the work and/or uses on-the-fly translation by known technologies such as machine translation systems. The invention's focus is instead on the novel presentation of translation results, and on associated concepts. The reader exercises extremely fine control over the manner in which the translation of a work is presented, by selecting for translation (or un-translation) specific pieces of the text in an order chosen by the reader. The invention responds to reader preferences for the display of a particular word, character, or phrase in a particular language; it infers these preferences from the reader's exercise of control over the presentation. The invention is also directed to the structures and algorithms that support the presentation, the reader's control of it, and the invention's responses to that control.

In one embodiment, the textual display on a handheld computer or other portable computing device with a touch screen adapts incrementally into a translation according to the demonstrated ability and progress of a particular reader during the incremental translation process. Examples of handheld computers suitable to be configured according to the invention include without limitation those sold with operating systems under the brands PALM and POCKET PC (marks of Palm Computing and Microsoft Corporation, respectively). In another embodiment, the display likewise adapts, but it is on a personal computer (e.g., an Apple Macintosh brand computer or a so-called “IBM PC or compatible” computer) equipped with a mouse, light pen, or other pointing device.

The invention provides methods for use by a system to incrementally immerse a reader in a translation as the reader traverses a cohesive text, and configured computer-readable storage media which cause a system to perform such methods. The term “cohesive text” is used in distinction with texts that are merely lists of words, phrases, grammar rules and pedagogic examples, and the like. Cohesive texts are texts that use sentences to tell a story, explain an idea, advocate a position, or otherwise engage readers; they are often texts that someone already fluent in the translation language would read for enjoyment or learning quite apart from any desire to improve their language skills.

One method comprises the steps of: displaying on a display a displayed text portion which is at least a portion of the cohesive text, the displayed text portion being at least partially in a first language; receiving a selection of a selected text which is at least part of the displayed text portion, the selection being made by the reader as a request for translation of the selected text, the selected text belonging to a linguistic unit such as a word or phrase; obtaining in response to the selection a counterpart text of the specified linguistic unit, the counterpart text being at least partially in a second language, the counterpart text being a translation of the selected text; displaying the counterpart text on the display; noting in a data structure a preference of the reader for display of the counterpart text; and subsequently displaying the counterpart text, without requiring a further request from the reader for translation of the selected text into the counterpart text, when another instance of the linguistic unit is encountered during the reader's traversal of the cohesive text. Note that “linguistic unit” refers generally to a piece of information that can be expressed, via textual counterparts, in two or more languages.

The counterpart text may replace the selected text, or merely supplement it. State information specifying preferences for displaying particular linguistic units in particular languages may be preloaded into system memory, and the preloaded information or other preferences, such as those inferred from reader translation requests, may be edited by a reader. In alternative method embodiments, text is spoken, and/or comments about grammar or vocabulary are displayed. Translations may be animated in various ways to illustrate translation features such as differences in sentence word order, proper oriental character stroke order, or other concepts. More than two languages may be translated and displayed. Translations are obtained by steps such as a lookup to obtain counterpart text in a particular language from a table of linguistic units, a lookup in a dictionary such as a conventional dictionary that is also useable apart from the inventive method, and/or an on-the-fly translation by a machine translation service such as a conventional service that is also useable apart from the inventive method.

The invention likewise provides methods for use by a reader who wishes to be incrementally immersed in a translation while traversing a cohesive text. One such method comprises the steps of: viewing on a display a displayed text portion which is at least a portion of the cohesive text, the displayed text portion being at least partially in a first language; selecting a selected text which is at least part of the displayed text portion, the selection being made by the reader as a request for translation of the selected text; viewing a counterpart text on the display, the counterpart text being a translation of the selected text; indicating a preference for display of the counterpart text (e.g., by leaving the counterpart text on display, or by selecting the counterpart text from several offered counterpart texts, or by typing in the counterpart text which will then be stored by the program as the translation to use); and subsequently viewing the counterpart text, without making a further request for translation of the selected text into the counterpart text, when another instance of the selected text would otherwise have been encountered during traversal of the cohesive text.

Variations comprise additional steps such as preloading into a computer memory state information specifying preferences for displaying particular linguistic units in particular languages; viewing and editing a list of accepted translations, in which translation of the selected text into the counterpart text is among the accepted translations; viewing an animation of a translation between the selected text and the counterpart text; and preparing the cohesive text by submitting a copy of text in a first language to a computer for transformation into a format supporting incremental immersion.

A method of the invention for transforming a literary work provided by a user in at least a first language to obtain a format that supports incremental immersion in a translation of the work comprises the steps of: dividing the work into linguistic units, each linguistic unit having a text in the first language; obtaining translation of the first language text of the linguistic units into a second language; building in a data structure ordering instructions for placing the linguistic units in order to display a copy of the work as cohesive text in the first language; and building in the same or another data structure selection state information indicating which linguistic units should be displayed as text in which language such that the preference is tied to the linguistic unit, so further requests to display the linguistic units in preferred languages are not required.

A system of the invention for reader-guided incremental immersion in a translation comprises: a selection input device; a display output device; textual units from a cohesive text; selection state information indicating a language preference for display of the textual units; and at least one processing component which receives from the selection input device a selection of text that is displayed on the display output device, which changes the selection state information to indicate a different language preference for display of the selected text, and which sends the translation to the display output device to be displayed. The translation is subsequently displayed in conjunction with another instance of the selected text as a result of the change in the selection state information and without requiring any further request through the selection input device for translation of the selected text.

The processing component comprises special-purpose hardware and/or software in a system such as a handheld computer or a client computer in a computer network. The selection input device may be a touch screen, for instance, or a screen in combination with a pointing device such as a mouse. In some embodiments, the processing component comprises at least one of: a tree data structure containing selected text, translations thereof, implicit order information for displaying text, and selection state information; a table data structure containing selected text, translations thereof, and selection state information, in combination with another data structure containing order information for displaying text; and a first data structure containing selected text and translations thereof, in combination with at least one other data structure which contain(s) order information for displaying text and selection state information.

Alternative systems display comments in conjunction with the selection of text, operate in a server and client connected via connectivity components, transform a literary work into a format that supports incremental immersion in a translation of the work, preload selection state information into a system memory to specify preferences for displaying particular texts in particular languages, and/or animate on the display a transition between text translations. Some embodiments speak the translated text out loud; in some this capability is merely an option, and in others it is not provided. An inventive device may speak the translated text by playing back a recording of the translated portion of text, by utilizing text-to-speech synthesis technology, or both.

Other aspects and advantages of the present invention will become more fully apparent through the following description.

### BRIEF DESCRIPTION OF THE DRAWINGS

To illustrate the manner in which the advantages and features of the invention are obtained, a more particular description of the invention will be given with reference to the attached drawings. These drawings only illustrate selected aspects of the invention and thus do not fully determine the invention's scope. In the drawings:

FIG. 1 shows a handheld computer displaying a text which is partially translated, in an embodiment providing incremental immersion in French or English according to the present invention.

FIG. 2 is a schematic block diagram showing components of systems according to the invention, including for instance systems like those shown in FIGS. 1 and 12.

FIG. 3 is a schematic block diagram showing components in an alternative embodiment of the invention.

FIG. 4 is a schematic block diagram showing components in another alternative embodiment of the invention.

FIG. 5 is a diagram illustrating a node data structure for use in an embodiment of the invention.

FIG. 6 is a diagram illustrating an alternative node data structure for another embodiment of the invention.

FIG. 7 is a diagram illustrating a tree data structure with an example of an incremental translation result for display according to the invention.

FIG. 8 is a diagram illustrating the tree data structure of FIG. 7 modified to display a different incremental translation result.

FIG. 9 is a flowchart illustrating methods of the present invention, from the perspective of a device or system that displays incremental translation results.

FIG. 10 is a flowchart illustrating methods of the present invention, from the perspective of a person who is using a device or system that displays incremental translation results.

FIG. 11 is a flowchart illustrating alternative methods of the present invention.

FIG. 12 is a schematic block diagram showing components in a server-based embodiment of the invention and its context.

FIG. 13 illustrates a table data structure in an example of an incremental translation according to the invention.

FIG. 14 illustrates an incremental translation display and an internal encoding thereof, which use the table data structure of FIG. 13.

FIG. 15 illustrates a formatted string data structure in an example of an incremental translation according to the invention.

FIG. 16 illustrates an incremental translation display and an internal encoding thereof, which use the formatted string data structure of FIG. 15.

FIG. 17 illustrates stages in the display of incremental translation results between Chinese and English texts according to the invention.

### DETAILED DESCRIPTION OF THE PREFERRED EMBODIMENTS

In describing methods, devices, configured media, computer programs, products, and systems according to the invention, the meaning of several important terms is clarified, so the claims must be read with careful attention to these clarifications. Specific examples are given to illustrate aspects of the invention, but those of skill in the relevant art(s) will understand that other examples may also fall within the meaning of the terms used, and hence within the scope of one or more claims. Important terms may be defined, either explicitly or implicitly, here in the Detailed Description and/or elsewhere in the application file. In particular, an “embodiment” of the invention may be a system, an article of manufacture, a method, and/or a signal which configures a computer memory or other digital or analog computer-readable medium.

Overview

The invention provides tools and techniques which can assist in learning foreign languages and other “languages”, including natural or artificial languages. Suitable languages include “natural languages” such as Arabic, Chinese, English, Esperanto, French, German, Icelandic, Japanese, Korean, Latin, Russian, Spanish, and many, many others. Such languages often have an associated culture, history, prevailing geography, and other influences, and a large and interesting literature.

Translation could also be performed with the invention between dialects of a natural language, such as American English and British English. Translation could also be performed with the invention between different subsets of a single natural language, such as “easy” versus “hard” English, with the subsets defined according to difficulty using measures such as sentence complexity, vocabulary differences, or the like, in a manner analogous to definitions used in measuring students' reading ability, for instance. Alternatively, language subsets could be defined according to their “jargon” content, e.g., the extent of their use of legal or medical terms of art.

To a limited extent, suitable languages for use according to the invention also include certain “artificial languages”, such as certain notational languages that typically have limited grammar and limited applicability outside relatively narrow technical arenas. Artificial languages include, for instance, the notational language of symbols used to describe chemical compounds and reactions, and the notational language of mathematical symbols, equations, and theorems. For instance, a chemical equation can be viewed as a sentence. The chemical equation “2H2+O2→2H2O”, which represents the chemical reaction of hydrogen and oxygen to form water, can be translated into English as “Two hydrogen molecules plus one oxygen molecule combine to form two water molecules.” Likewise, the mathematical sentence

∫e^{x}dx=e^{x}+c

can be translated into English as “The integral of e to the x with respect to x equals e to the x plus a constant c.”

A “translation” according to the present invention always involves at least one natural language. Thus, converting an equation into another equation is not “translation” if both are presented in symbolic form. Nor is showing the derivation of a variable (as in a spreadsheet, for instance), or the derivation of an equation (as in proof of a trigonometric identity, for example). Mere mathematical calculations, whether numeric, algebraic, or symbolic in form, are likewise not “translations” as that term is used herein. Neither is converting between computer languages, e.g., between C and C++, C and assembly, Pascal and p-code, or assembly and machine language.

In general, the invention presents a reader with text in a source language, such as the reader's native natural language or another language the reader is comfortable in. As the reader reads the text, the reader is able to select parts of the text to be translated, without necessarily being prompted by the invention as to which parts should be translated. The selected text portion may be a word, a character (e.g., in Chinese), a clause, or another set of words, sentence(s), paragraph(s), etc. The selected text is then automatically supplemented or replaced by corresponding text in a destination language, such as a foreign language the reader is learning or is otherwise curious about.

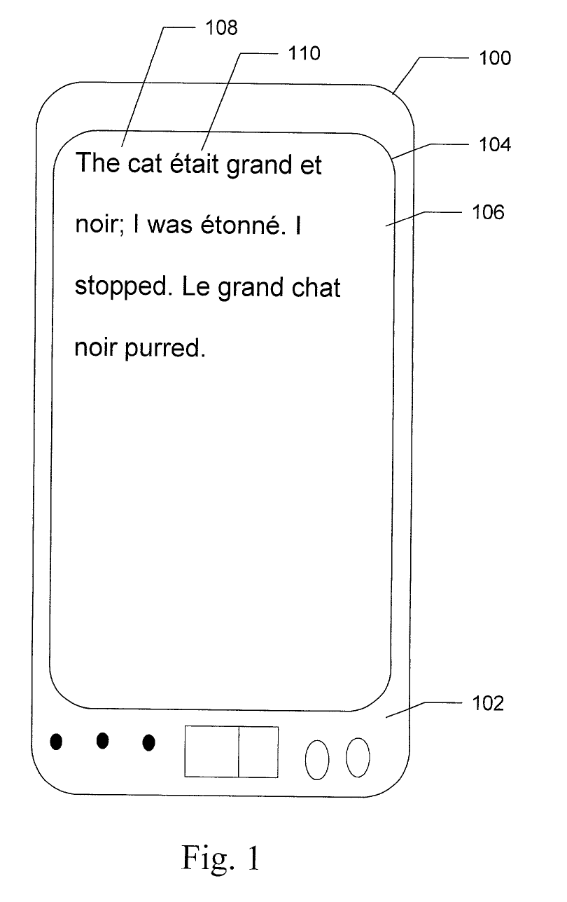

As a result, the text is incrementally translated from one language to another. Along the way, partial translations are preferably displayed in response to reader requests for translation of individual pieces of the larger text. This is illustrated, for instance, in FIG. 1, which shows an embodiment of the invention in a handheld computing device 100. The device 100 may be a Palm brand, Handspring brand, or other handheld computing device (marks of their respective brand owners). Such devices typically have an interface portion 102 comprising buttons, screens capable of character or other pattern recognition, LEDs, and/or similar components; different embodiments of the invention may utilize various combinations of some or all of these components, and/or other familiar interface components. The device 100 also has a visual display 104. The display 104 may be an output-only display, or it may accept input as well as provide output. For instance, the display 104 may be a “touch screen” of the type used on commercially available handheld computing devices.

Part or all of a cohesive text 106 is displayed on the display 104 of the device 100. The text 106 is not merely a vocabulary list. Rather, it is a cohesive text with sentences, and is preferably a text that a native speaker of one of the languages involved might normally read for business or pleasure. That is, text 106 is preferably selected by the reader primarily for the sake of its content, as opposed to being selected by someone else and then presented to the reader as part of a language course. For instance, the text 106 may tell a story, report an event, advocate a position, or describe a technology. Accordingly, the present invention may be used to incrementally immerse readers in partial translations 106 of novels, short stories, magazines, journals, newspapers, bandes dessinées, children's books, and other literary works at various levels of difficulty that are often read quite apart from any foreign language learning effort. Such texts 106 may be called “independently interesting cohesive texts” to distinguish them from mere vocabulary lists or other mere lists (which are not “cohesive”), and to indicate their interest to readers independent of their use in learning a foreign language.

Embodiments of the invention may be used with language courses, but they are not necessarily substitutes for such courses—or for live instruction from a foreign language teacher—because embodiments of the invention do not necessarily contain predefined lessons. Instead, embodiments present in context translations of words, phrases, characters, and/or sentences, as readers request them, and the embodiments remember those requests. This frequently results in the display of partial translations. For instance, the displayed portion of text 106 includes both portions 108 that are in one language (e.g., English “The cat”) and portions 110 that are in another language (e.g., French “était”).

In the device 100 and in other embodiments, the transition between texts 108, 110 in the two languages can be animated in various ways to help the reader remember that one displayed text is a translation of the other displayed text and otherwise improve the reader's language skills. Animation is discussed in greater detail below.

The invention keeps track of translations requested by the reader, and when a previously translated text portion is encountered again, it is displayed in translated form in the destination language. The reader can reverse a translation, after which the reversed instance and all other instances of the text in question will be displayed in the source language rather than the destination language.

In this manner, the reader can be incrementally immersed in a foreign language text, at a rate and in a manner that is chosen by the reader, e.g., by translating nouns in a sentence before verbs, or by translating word-by-word from the start of a sentence to its end. The invention “remembers” which translations have been accepted (namely, those which have been done and not yet reversed), and it displays text in the source language or in the destination language accordingly. To put it differently, the text transforms itself piece by piece from one language to another, with the reader choosing which pieces to transform (or untransform) and the text being displayed accordingly.

The invention is thus tailored to the language skills of a particular reader at a particular stage in that reader's progress. For instance, reader A and reader B might well choose different portions of text 106 to transform, so their experience of a given source language text as it morphs into a given destination language may differ, even if both readers start with the same complete text in the same source language and pursue its translation into the same destination language. Likewise, someone who reads a text and incrementally translates it according to the invention may have very different experiences of the text at different times, even though the source text as a whole (i.e., displayed and undisplayed portions), the destination text as a whole, the source language, and the destination language are the same at each of those different points in time. Such a person may start a second reading of the text 106 with more of the text initially displayed in the destination language, for instance. Or they may start with the same initial display each time, but select different text portions (and/or the same portions in a different order) for translation between the two languages.

What a given reader learns can be carried forward from one article, book, poem, or other work to another. Thus, if the reader has accepted translation of a given word, for instance, during the reader's interaction with a first work 106, then in some embodiments that word will be (at least by default) displayed in translated form in the second work.

Architecture Examples

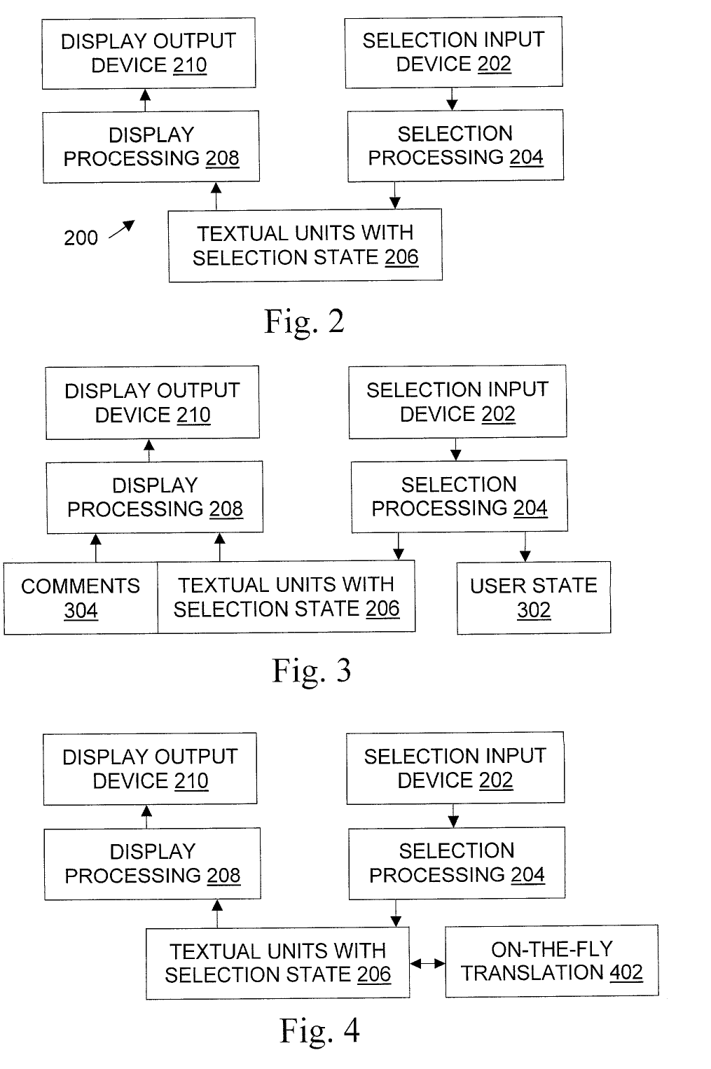

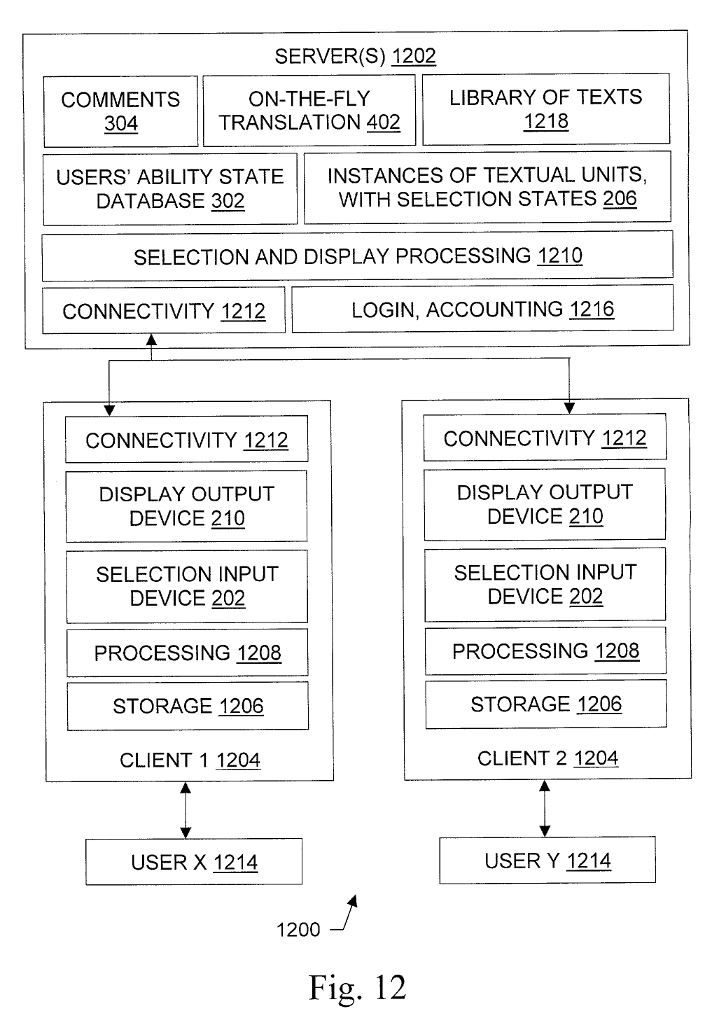

FIGS. 2-4 and 12 illustrate some possible architectures for systems and devices according to the invention. Devices or systems having different architectures may also operate according to the invention, so these figures are provided as examples, not as the only possible approaches. As used here, a “system” may be a single device such as a configured handheld computer, a larger computer, or a collection of several connected computers, depending on the circumstances. Thus, the architectures of FIGS. 2-4 may be implemented in devices such as handheld computers, in larger systems such as laptops or workstation computers, or in networked (client-server or peer-to-peer) systems. FIG. 12, which is also discussed directly in a later section, is more detailed than FIGS. 2-4 in that it illustrates an architecture 1200 that assumes at least two computers are present and that they are connectable by one or more networks.

In an architecture 200, information generally flows from a selection input device 202 through a selection processing component 204, which refers in turn to textual units and related information in a linguistics unit component 206. Some of the textual units are employed by a display processing component 208 which drives a display output device 210. The selection input device 202 may be a touch screen, for instance, or a monitor (e.g., CRT or flat panel display) in combination with a mouse or other pointing device. The display output device 210 may be (and often will be) the same screen as the selection input device 202, but can be separate.

As a simple example, assume the same display is used for input 202 and output 210, and assume that it initially displays the following sentences: “The cat was large and black. Where is the cat?” Now assume the reader selects “The cat”. Depending on the embodiment, this selection could be made for instance by touching the portion of a touch screen that displays “The cat”, by using a mouse to click on “The cat”, or by dragging a cursor over “The cat”, in familiar word-processor manner. The selection processor 204 receives a specification of the selection and accesses the textual unit and state component 206. The selection processor 204 determines that the language selection state of “The cat” within the component 206 is currently “English”, and changes that selection state to “French.” Control is then passed to the display processor 208, which notes the change in selection state, locates all displayed instances of “The cat” or “the cat”, and instructs the display 210 overwrite those instances with “Le chat” or “le chat”, respectively. Surrounding text is repositioned as necessary, in a manner similar to that used when a word processor does a string replacement. As a result, the display changes, so that it shows the following: “Le chat was large and black. Where is le chat?”. If the reader then presses a scroll or page down command, for example, which brings additional text into view, that text is displayed as, e.g., “That is not le chat that I saw yesterday” rather than “That is not the cat that I saw yesterday”, without another translation request from the reader.

The selection processor 204 and the display processor 208 are shown as separate components in the figures, but they may be implemented in software in a single file, package, module, handler, class, method, routine, procedure, function, or other implementation component. Likewise, the texts in different languages and the current selection state indicating which piece of text is to be displayed in which language are illustrated as a single component 206, but they may be implemented in multiple files, tables, lists, variables, or other structures.

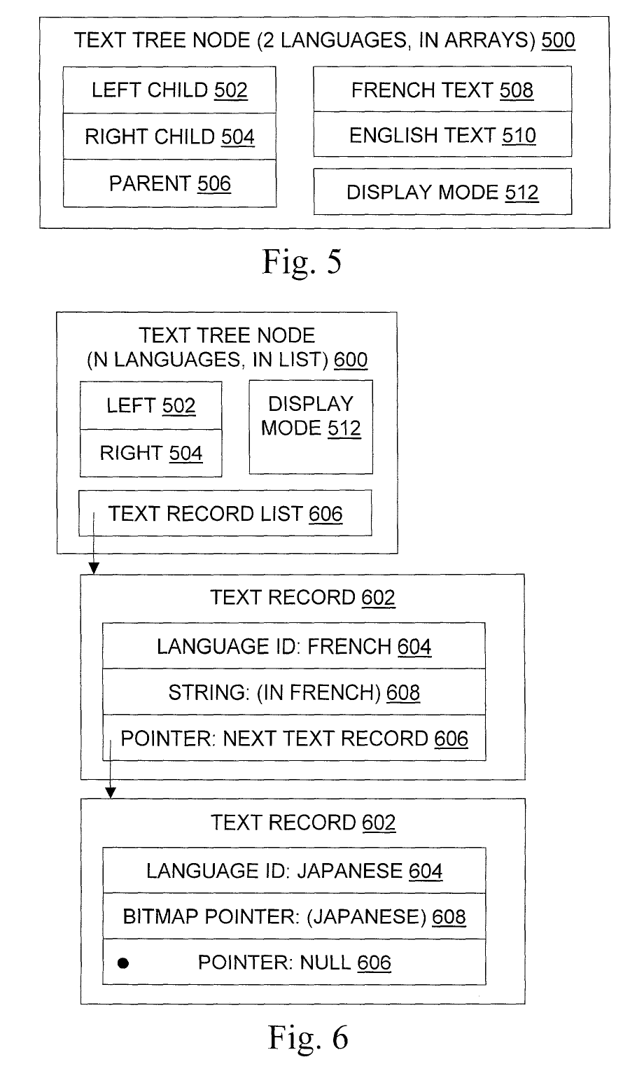

To support incremental immersion, the inventive system includes several pieces of basic information, which may be embedded in component 206 for instance, via appropriate data structures and algorithms (see, e.g, FIGS. 5-8, 13-16). These pieces of basic information are:

1. A collection of characters, words, phrases, sentences and/or other linguistic units in a given language and their counterparts in at least one other language;

2. Ordering instructions for placing instances of the linguistic units in order to provide a cohesive text; and

3. Selection state information indicating which linguistic units should be displayed in which language; this ties particular languages to particular linguistic units for display purposes, so users need not manually switch between languages once their preferences (or default preferences) are noted.

In the previous example, for instance, the collection of linguistic units could be defined in various ways, one of which comprises the linguistic units “The cat”, “was”, “large”, “and”, “black”, and “Where is”. If we number these linguistic units from one to six, respectively, then the ordering instructions for composing the display text “Le chat was large and black. Where is the cat?” are the same as those for composing the display text “The cat was large and black. Where is the cat?”, namely, “1 2 3 4 5 6 1”. However, the selection state information for the first display text differs from that for the second display text in that the first specifies that linguistic unit “Le chat|The cat” should be displayed in French while the second specifies display of that unit in English. Capitalization may be treated by separate processing, so that “Le chat” is displayed at the beginning of a sentence, while “le chat” is displayed elsewhere in a sentence. A piece of punctuation may be treated as any other linguistic unit, or it may be treated as a special linguistic unit which is displayed the same in both languages. For instance, the double quote mark in English may be translated into angle brackets in French, whereas periods and commas in prose sentences (but not in numbers) require no translation between those two languages. In addition to putting strings or bitmaps for textual displays into a linguistic table, grammatical information could be included in the table, so that the table (or another data structure of linguistic units) contains information about the grammatical role played by at least some of the table entries.

FIG. 3 illustrates an architecture 300 like that shown in FIG. 2, but with two more components. A user-specific state structure 302 keeps track of which linguistic units are to be displayed in which language for a given user, independent of any particular text 106. The structure 302 may duplicate information found in component 206, in the same or different data structures, or the structure 302 may be used in place of other selection state data structures. Unlike selection state structures that are embedded in or otherwise closely tied to a particular literary work, the structure 302 is work-independent. For example, suppose user X encounters “The cat” in a mystery novel, and accepts translation of “The cat” into “Le chat” in that context. X then puts the novel aside and turns to another work that is formatted for use with the invention, such as a magazine article that discusses house pets. Instead of displaying “The cat” in the context of the magazine article, an inventive embodiment utilizing structure 302 will display “Le chat” the first time that linguistic unit is encountered.

FIG. 3 also illustrates a comments component 304. The components 302, 304 are not necessarily linked; either, both, or neither of them may be used in a given embodiment, and they are both shown in FIG. 3 simply to conserve space. The comments component 304 contains comments that correspond with linguistic units in the text component 206, so that comments about a particular translation can be displayed when the translation is made. For instance, when the user translates “The cat” to “le chat”, a comment on the display might state “Chat is masculine.” Comments may be given regarding case, conjugation, tense, declension, and/or other grammatical concepts.

FIG. 4 illustrates an architecture 400 like that shown in FIG. 2, but includes an on-the-fly translation component 402. This is included to illustrate that the collection of linguistic units need not be entirely embedded in structures created specifically for use in the invention. As long as at least one instance (in one language) of a linguistic unit is present, a counterpart in another language can be determined either by looking it up in the component 206, or by querying on-the-fly a previously separate component 402, such as a machine translation service 402 or a previously separate electronic dictionary 402.

For example, one embodiment might store both “The cat” and “Le chat” in its internal collection of linguistic units, in a manner that indicates these are each instances of the same linguistic unit; this would not require an “on-the-fly” translation. Another embodiment might store only “The cat” and obtain the translation “Le chat” on-the-fly, when the user asks for it. This embodiment goes beyond mere machine translation, because the embodiment notes that translation of “the cat” was accepted, and it will display “Le chat” for the subsequent instances without any further translation request from the user.

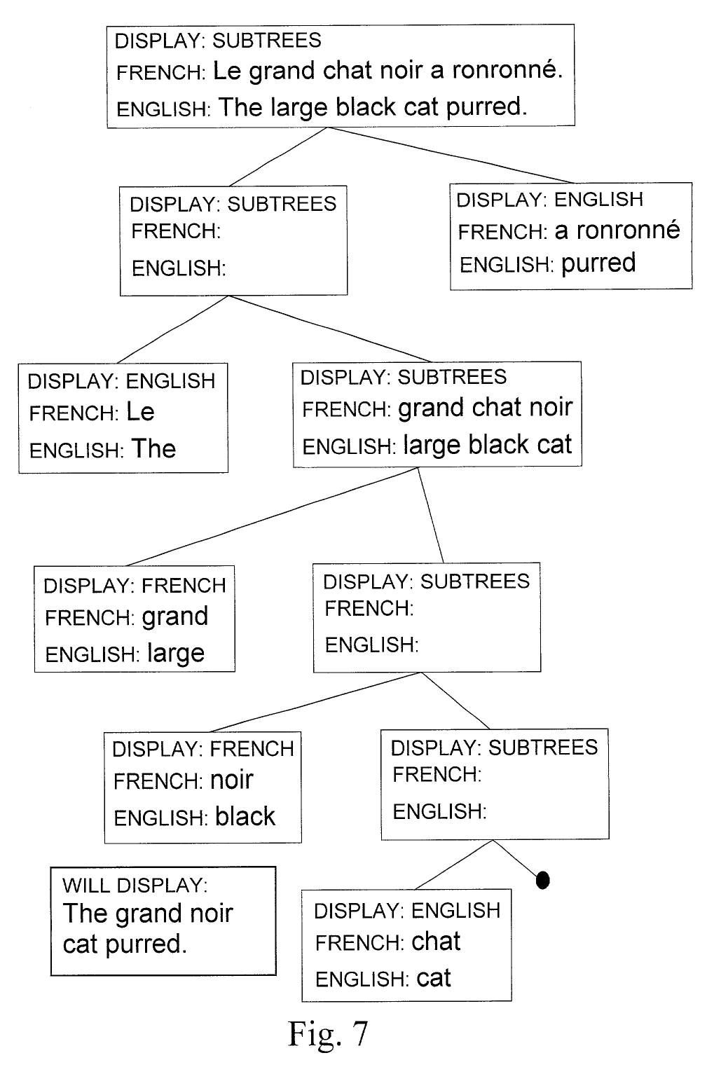

In short, some of the examples given here (e.g., the data structures in FIGS. 7, 8, 13 and 15) have all counterpart instances of a given linguistic unit embedded within a data structure created specifically for use in the invention. But other embodiments of the invention can obtain some or all foreign language counterparts by passing a machine translation service 402 or a dictionary service 402 the native language an instance of the linguistic unit in question.

Additional Display Examples

To better illustrate the invention, some additional specific examples will now be discussed. Those of skill will understand the operation of the invention by generalizing from these examples, and the necessary data structures and procedures for software embodiments can be inferred from the description herein by a skilled programmer or software engineer.

In one display embodiment, the source and destination languages are displayed next to each other, with spacing as needed to permit easy visual correspondence of individual words, oriental characters, or other units, e.g.:

| | | | | | |
|---|---|---|---|---|---|
| The | cat | was | large | and | black. |
| Le | chat | était | grand | et | noir. |

In one display mode, the reader may select words and accept them for translation by making them disappear from the display, e.g., an English reader may accept translation of “cat” into “chat”:

| | | | | | |
|---|---|---|---|---|---|
| The | | was | large | and | black. |
| Le | chat | était | grand | et | noir. |

In another mode, the display is animated, to show movement of the translation into the position previously occupied by the corresponding portion of the source text. In the previous example, “chat” would travel upward (via pixel bit block movement or other graphics techniques), leading to:

| | | | | | |
|---|---|---|---|---|---|
| The | chat | was | large | and | black. |
| Le | | était | grand | et | noir. |

In other display modes in various embodiments, words/characters morph into their translation, or they fade out as the translation fades in.

The display could also be originally entirely in the source language, with the selected text flipping back and forth discretely between the languages as the source and destination language versions of the selected text overwrite each other at the same screen location, so that, e.g., the same part of the screen shows each of the following lines of text at successive two-second intervals:

The cat was large and black.

Le chat was large and black.

The cat was large and black.

Le chat was large and black.

The cat was large and black.

Le chat was large and black.

After the transition from English “The cat” to French “Le chat” is complete, the display remains at “Le chat was large and black.” and translation from “The cat” to “Le chat” is deemed to be accepted.

As noted, the invention remembers the acceptance of this translation, so that other instances of “The cat” or “the cat” will now be displayed as “Le chat” or “le chat”, respectively, unless and until the reader reverses the translation to replace the French version once again with the English version. Thus, if the text has another phrase somewhere that is “Where is the cat?” in English, it will be displayed as “Where is le chat?” rather than “Where is the cat?” because the translation from “the cat” to “le chat” has been accepted by the reader.

Some Translation Issues and Supporting Structures

Translation may proceed word-by-word and then in larger units that automatically revise the earlier translation without an express reader request. When a phrase or sentence is reached, the entire phrase or sentence is then translated; a translation of a phrase or sentence is not necessarily literal. In particular, translating a group of words may involve changes in the previously accepted translation of a given word, and/or changes in word order. For instance, successive views of the same sentence might be:

I do not need you anymore.

Je do not need you anymore.

Je n'ai pas besoin de you anymore.

Je n'ai pas besoin de vous anymore.

Je n'ai plus besoin de vous.

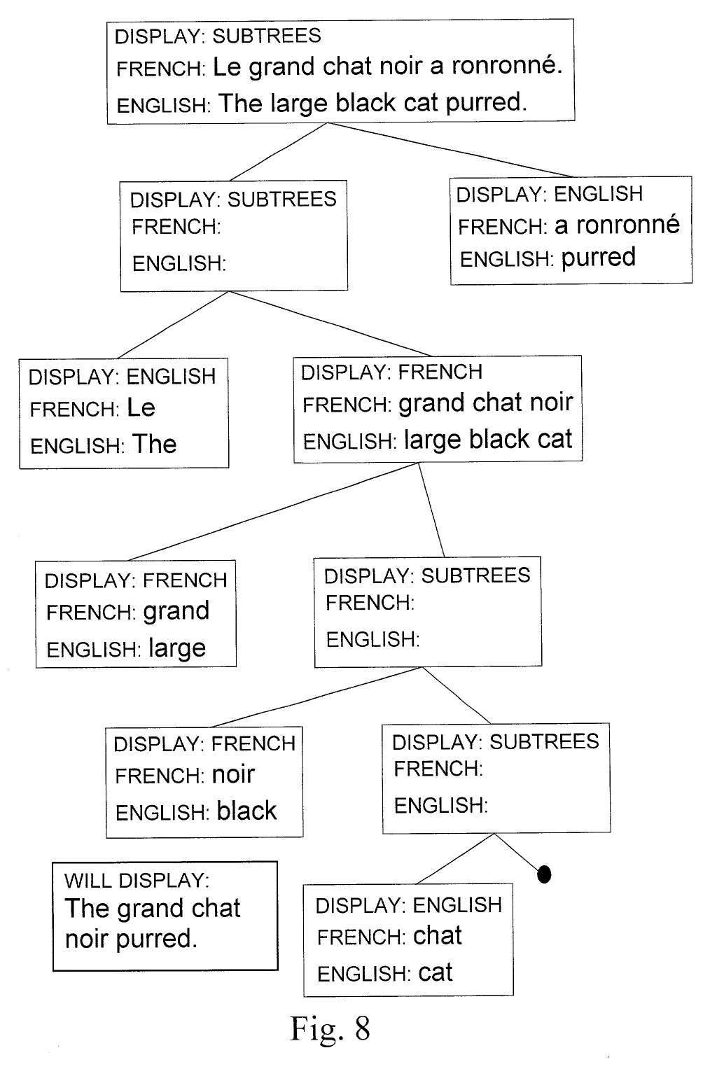

Another example is illustrated in FIGS. 5-8. FIGS. 5 and 6 show tree node data structures, while FIGS. 7 and 8 show two instances of a tree data structure using those or other node data structures. The illustrated tree data structure supports changes in word order for a translation into French of the English phrase “large black cat”. A literal word-for-word translation of “large black cat” is “grand noir chat” but a translation of the phrase as a single linguistic unit orders the French words differently: “grand chat noir”.

Trees like those illustrated in FIGS. 7 and 8 can be implemented using nodes that point to one another, such as those shown in FIGS. 5 and 6, or others. Tree nodes may be implemented using C structs, Pascal records, or similar constructs in other programming languages. Pointing can be implemented using memory addresses obtained from dynamic allocators such as C's malloc or C++'s “new” operator; pointing can also be implemented using array indices.

FIG. 5 illustrates one node structure 500 for a binary tree data structure. The node 500 has a left child pointer 502 pointing to the node's left child in the binary tree, if any, a right child pointer 504 pointing to the node's right child in the binary tree, if any, and a parent pointer 506 pointing to the node's parent in the binary tree, if any; a null parent pointer means the node is the tree's root node. Two arrays 508 and 510 hold strings representing French and English counterparts, respectively, of a given linguistic unit. In an alternative embodiment, pointers to bitmaps are used instead of strings, e.g., for character languages such as Chinese, although other character representations such as Unicode can also be used. Regardless, a display mode field 512 indicates which language the linguistic unit represented by the node 500 should be displayed in.

FIG. 6 illustrates an alternate node structure 600. The differences between the structures 500 and 600 can be mixed and matched in various ways in other embodiments; to conserve space, only two of the many possible structures are illustrated. The structure 600 stores linguistic unit strings or bitmaps 608 in a linked list of dynamically allocated text records 602 rather than in ordered fields. By contrast, in structure 500 the fields are ordered so the first field is always French, and the second is always English. Each text record 602 contains a language identifier 604, and at least one pointer 606 to another text record 602 in the list. In addition to order changes, this approach allows relatively easy addition or removal of other languages, since it is easier to add text records 602 to a linked list of text records for node 600 than it is to add new fields to a record or struct implementing node 500.

To produce the displayed text from a tree like the ones shown in FIGS. 7 and 8, a processor component 208 can do a recursive tree traversal beginning at the root, using an implementation of pseudo-code such as the following:

PROCEDURE DisplayTree(R: tree node)

IF R is null THEN return;
IF R.Display is ENGLISH THEN

DisplayToScreen(R.ENGLISH);
Return;

END IF;
IF R.Display is FRENCH THEN

DisplayToScreen(R. FRENCH);
Return;

END IF;
IF R.LEFT is not null THEN DisplayTree(R.LEFT); //traverse left
subtree
IF R. RIGHT is not null THEN DisplayTree(R.RIGHT); //traverse
right subtree

END DisplayTree.

Null pointers are generally indicated in FIGS. 7 and 8 by omitting from those figures the lines that would otherwise indicate links between nodes; a line terminated in a dot rather than a node structure in the bottom right part of each figure also indicates a null pointer. Depending on the size of the text 106 and the memory and processing speed capacities of the computer being used, it may be preferable to limit or avoid use of trees by using, e.g., tables of linguistic unit counterparts instead of trees; trees may require more memory and/or processing than is desired. Those of skill will determine what data structures to use in a given implementation of the invention.

In some embodiments, each individual word/oriental character is selectable. In others, some larger predefined linguistic units are selectable instead of their component words. For instance, in some embodiments, “the” and “cat” may be separately selectable in the sentence “Where is the cat?”, while in other embodiments, only the article-plus-noun linguistic unit “the cat” is selected when a reader taps/clicks on either “the” or “cat”. Tapping pertains to touch screen input, while clicking pertains to input from a positioned mouse cursor, light pen, or other pointing device.

Overlapping selectable units (e.g., permitting selection of either a word or a phrase containing the word) may be supported using trees as just discussed, or using tables containing both selectable units as entries. Some embodiments select a word, a larger overlapping grammatical unit (e.g., noun plus article or verb plus preposition), an overlapping sentence, or an overlapping paragraph, for instance, depending on whether the reader taps/clicks once, twice, three times, or four times in succession at a given point on the display, respectively. For instance, tapping once or clicking once on “rice” in the sentence “Rice with coconut is good.” might select “Rice”, while tapping/clicking twice on “rice” selects “Rice with coconut” and tapping/clicking three times on “rice” selects the entire sentence. The selected text portion is then replaced by the translation into the destination language (Arabic, Chinese, French, German, Russian, Spanish, etc.). The transition to the destination language may be rapid and simple, or it may be slower with animation of some sort. As noted, the display may switch back and forth between the two languages to emphasize the relationship of the given word/phrase/sentence to its translation.

When the selected text contains more than a single word (or more than a single character, in oriental languages such as Chinese, Japanese, and Korean), the text in one language may order those units (words, characters) differently than the order of their counterparts in the other language. For instance, the German translation of “Have you read the book?” is “Haben Sie das Buch gelesen?”, which translated back into English word-by-word (literally) is “Have you the book read?”.

FIGS. 7 and 8 illustrate a way to implement support for word order changes by using trees with differently ordered counterparts displayed depending on the tree nodes that are traversed in response to display settings. For example, departing slightly from the specific illustrated example, one traversal gives “grand noir chat” while another gives “grand chat noir”. Other implementations of word order changes may also be used.

More About Methods

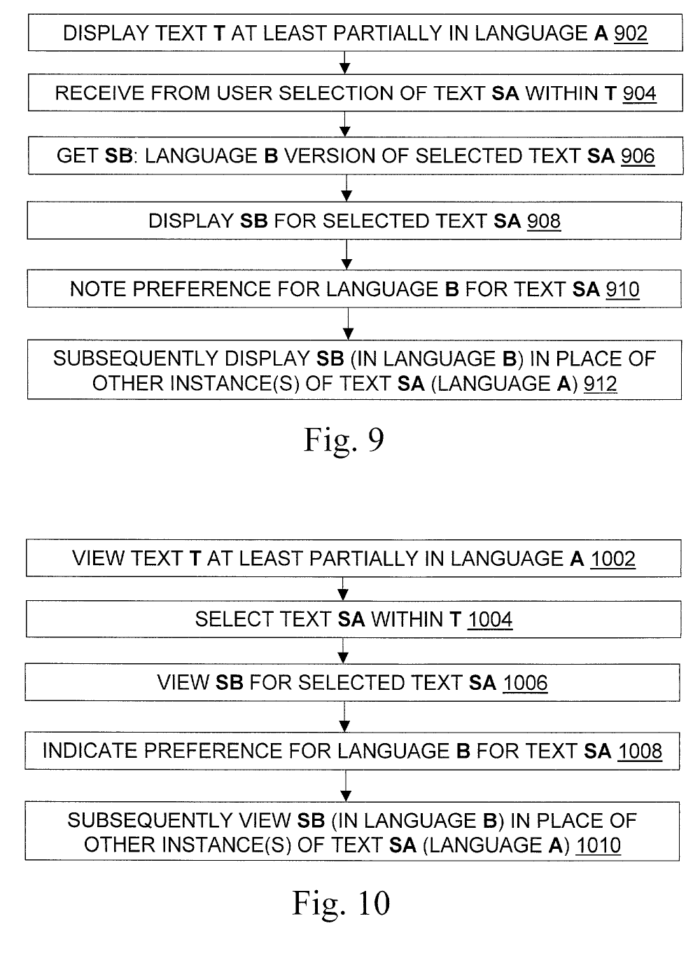

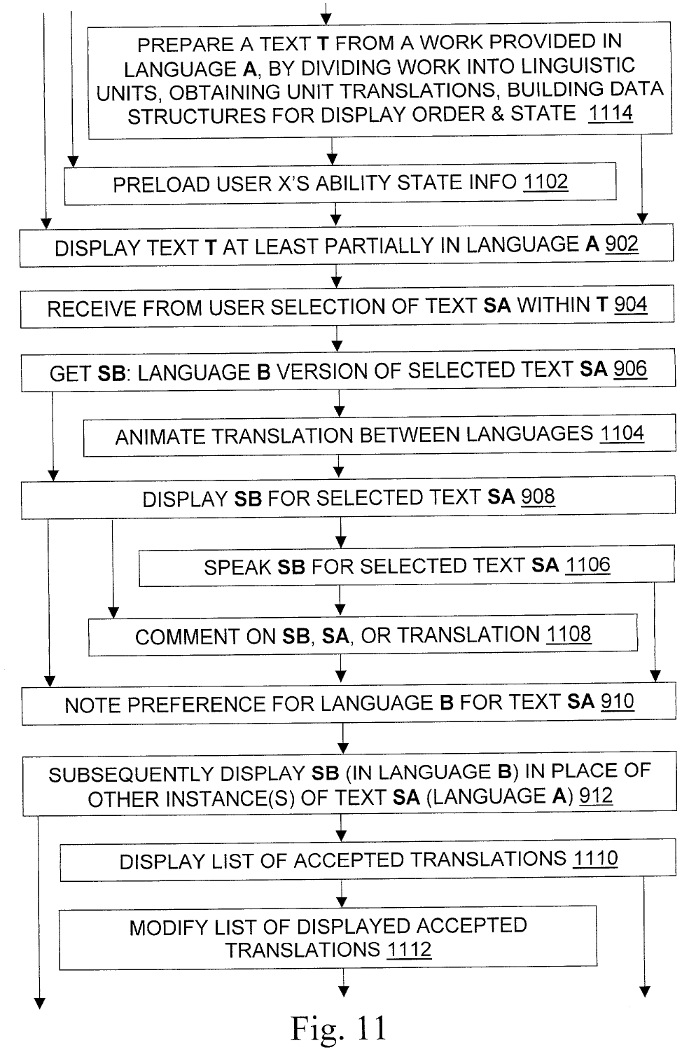

FIGS. 9-11 further illustrate methods of the present invention. FIG. 9 shows method steps from the perspective of an inventive device or other system, while FIG. 10 shows methods from the perspective of a person who is using such a system. FIG. 11 elaborates on FIG. 9. Like FIG. 9, FIG. 11 is from a system perspective. A similar elaboration of methods from the user perspective may be made by expanding FIG. 10 in a way similar to the expansion of FIG. 11 from FIG. 9, but to reduce repetition that expansion is not drawn out in a separate figure.

FIG. 9 illustrates a method 900 for use by a system, such as device 100 or networked system 1200, to incrementally immerse a reader in a translation as the reader traverses a cohesive text. The method includes a displaying step 902, during which text T in a language A is displayed. In the example of FIG. 1, text 106 in both English and French is displayed. In a different example, all of a text 106 could be initially displayed (or noted as preferred for display) in English. In general, step 902 displays on a display such as output device 210 a displayed text portion which is at least a portion of the cohesive text 106, and the displayed text portion is at least partially in a first language.

During a selection receiving step 904, the inventive system receives a user selection of displayed text SA. For example, a user might select “The cat” as selected text SA after it is displayed 902. In general, step 904 receives a selection of a selected text which is at least part of the displayed text portion. The selection is made by the reader as a request for translation of the selected text. The selected text corresponds to a linguistic unit, which is thus selected. The selection is received at the selection input device 202 and conveyed to the selection processing component 204.

During a counterpart obtaining step 906, a translation of the selected linguistic unit is obtained by the display processor component 208 of the inventive system. This may be accomplished by consulting trees, tables, or other data structures that were created specifically for use with the invention, or it may be accomplished by an on-the-fly translation 402. In some embodiments a translation may also be obtained 906 from the reader, either through reader selection from a list of choices presented by the system, or by reader entry (e.g., typing) of text. In general, step 906 obtains in response to the reader's selection a counterpart text of the specified linguistic unit, the counterpart text being at least partially in a second language, the counterpart text also being a translation of the selected text. Step 906 is discussed further in another section below.

The counterpart SB is then displayed 908 to the user. Some embodiments replace the original text SA with the counterpart SB, while others supplement it so that both are (at least temporarily) displayed. Continuing the example, step 908 might display “Le chat” in place of “The cat” on the device 100.

Before, after, or during the translation obtaining step 906, but in conjunction with that step for the selected linguistic unit, the inventive system notes 910 the user's apparent change in preference regarding which language should be used to display a counterpart of the selected linguistic unit. Noting 910 may be accomplished by setting a bit, storing a value, or otherwise changing a variable such as a table entry or other data structure. For instance, this selection state change information can be recorded in the textual selection state unit 206 and/or in the user ability state structure 302.

Regardless of the location and details of the data structure used to record the user's acceptance of a translation of the linguistic unit, the recorded information indicates that the linguistic unit should be displayed in the language to which it is being translated, so that other instances of that linguistic unit will likewise be displayed 912 in the chosen language without further translation requests by the user. That is, the system subsequently displays 912 the counterpart text, without requiring a further request from the reader for translation of the selected text into the counterpart text, when another instance of the linguistic unit is encountered during the reader's traversal of the cohesive text.

FIG. 10 describes similar activity as a method 1000 seen from a user's point of view. The user views 1002 a displayed text 106 portion on a screen 210. By tapping the screen, clicking a mouse, or similar actions, the user selects 1004 part of the displayed text. Selecting displayed words is not itself new; it frequently occurs for instance in word processors. But in a word processor, merely selecting text does not indicate to the word processing program what should be done with that text—it might be subsequently cut, deleted, changed in font or size, or fed into a tool such as a spell checker or thesaurus, for example. Additional action is needed to indicate what operation should be performed on the selected text by the word processor. By contrast, in an embodiment of the present invention, selecting text preferably means “translate this text” and nothing else, so that no separate “translate” command is necessary. Accordingly, after selecting 1004 the text, the user promptly and without further effort views 1006 the text's translation. By leaving the translation in place (or by selecting one translation from an offered list of translations), the user indicates 1008 his or her preference for the translation rather than the original text. Other instances of the original text are subsequently displayed 1010 in translation, rather than in their original language, without forcing the user to translate the same word or phrase again each time it is encountered.

Thus, FIG. 10 illustrates methods for use by a reader to be incrementally immersed in a translation as the reader traverses a cohesive text. One such method comprises the steps of: viewing 1002 on a display such as device 210 a displayed text portion which is at least a portion of the cohesive text, the displayed text portion being at least partially in a first language; selecting 1004 a selected text which is at least part of the displayed text portion, the selection being made as a request for translation of the selected text; viewing 1006 a counterpart text on the display, the counterpart text being a translation of the selected text; indicating 1008 a preference for display of the counterpart text; and subsequently viewing 1010 the counterpart text, without making a further request for translation of the selected text into the counterpart text, when another instance of the selected text would otherwise have been encountered during traversal of the cohesive text.

Steps of method 900 and steps of method 1000 correspond generally in the following ways. System steps which display text, such as 902, 908, and 912, correspond to user steps which view displayed text, such as 1002, 1006, and 1010, respectively. A system step that receives selection input, such as step 904, corresponds to a user step that provides the user's selection as input, such as step 1004. Steps that make assumptions about the user's preferences based on user behavior, such as step 910, correspond to actions (or lack of action) by the user, such as step 1008. Some steps performed internally by a system, such as obtaining 906 the translation, have no direct counterpart in the user's method, which should generally be simple to avoid user distraction or confusion.

Steps of expanded system method 1100 of FIG. 11 likewise correspond to steps of a similarly expanded user method, not shown, in which FIG. 11 display steps correspond to user viewing steps, FIG. 11 input receiving steps correspond to user input providing steps, and so forth. Thus, an expanded user method includes steps such as preloading a file or table of one's display preferences for linguistic units; viewing text; selecting text to be translated; optionally viewing an animation of the translation; viewing the translation result; optionally hearing the device or system speak the translation result out loud; optionally viewing comments on the translation; viewing subsequent instances of the translated character, word, or phrase in its translated form without asking again that it be translated; optionally viewing a list of accepted translations; and optionally modifying that list.

Steps of FIG. 11 that were not already discussed expressly in connection with FIG. 9 will now be described. These steps are optional, in the sense that they are not necessarily required in every embodiment of the invention. More generally, any or all steps of the illustrated methods can be reordered, repeated, omitted, supplemented, grouped differently, and/or named differently, except to the extent that doing so contradicts the claims or makes the process inoperative. Likewise, any or all illustrated system components and can be located differently, repeated, omitted, supplemented, grouped differently, and/or named differently, except to the extent that doing so contradicts the claims or makes the system inoperative. As noted, a device is an example of a system.

During a preferences preloading step 1102, the previously accepted translations and/or other display preferences of a particular user are loaded into a memory of an inventive system, so they can be taken into account right from the beginning of a user's viewing of a given text 106. Preloading 1102 loads state information into a memory, thereby specifying preferences for displaying particular linguistic units in particular languages. This may be accomplished, for instance, by loading a structure 302 in which the user's preferences were tracked while the user incrementally translated part or all of another text 106. Thus, if the reader translates “cat” to “chat” while reading a mystery novel, and then turns to a magazine article, the system will initially display “chat” instead of “cat” unless and until the reader translates the linguistic unit back to “cat”.

In some embodiments, predefined lists of translations that are accepted by default can be loaded 1102 into the inventive system before or during the reader's traversal of a given work, to thereby conveniently better approximate the reader's current knowledge of the destination language(s). These lists are not necessarily generated solely by the reader during previous reading; they can be provided by a publisher to multiple readers. Readers can preferably easily untranslate (translate back to their source language) items in the predefined list, so the list's inaccuracies with respect to the reader's actual knowledge need not be a major impediment to the reader's enjoyment of the text 106 and the incremental translation process 1000.

Some embodiments allow a reader to override 1008 a predefined translation. That is, the reader can replace default translations (such as those preloaded 1102) with the reader's own translations. For instance, a reader may prefer one idiom translation to another, or the reader may wish to correct perceived errors in the translation of a particular word/character. For instance, the Chinese character [symbol] [symbol] might be translated by default as English “everyone” and the reader might override that default to make the accepted translation be “everybody”.

During an animating step 1104, the translation between languages is animated. This may include, for example, one or more of the following: animating movement of words or characters to illustrate differences in sentence order between two languages; animating the drawing of Chinese or other oriental characters to illustrate stroke order; showing movement on the display of the translation into the position previously occupied by its linguistic unit counterpart; morphing the shape of characters or words through keyframe animation or the like to change a displayed text into a display of its translation; fading one displayed text out and fading its counterpart in; flipping back and forth between two displayed texts, with each overwriting the other in turn at the same screen location; and altering font size, font type, font spatial orientation, and/or font color. In a quiz mode, some possible translations are shown 1104 on the display and the reader then selects 1008 one; if reasonably correct, it is used as the translation SB accepted by the reader. Animation is discussed further in another section below.

During a speaking step 1106, the system speaks out loud the translation of the selected text. This may be accomplished by playing video or audio clips, and/or by speaking synthesized speech. One embodiment speaks 1106 the counterpart text in conjunction with displaying it, by speaking it at the same time as the display, or within a few seconds of the display time.

During a comment displaying step 1108, the system displays a comment 304 on the translation of the selected text, a comment on the selected text and its grammatical characteristics, or both.

During an accepted translations displaying step 1110, the system displays to the reader a list of accepted translations, such as those memorialized in a structure 302 or in a component 206. Some systems allow display 1110 of multiple such lists organized in some manner, e.g., a nouns list and a verbs list, or a previous acceptances list and a today's acceptances list. This allows the reader to assess and monitor progress, and to review translations. In some embodiments, the reader can edit 1112 the list of displayed acceptances.

In some embodiments, the reader can review 1110 a list (or lists) of all possible translations for a given work 106 (or a portion thereof, such as a given poem or chapter of the work), and the reader can edit 1112 the list so that the system “learns” quickly which translations are already known to the reader. During editing 1112, the list is modified in response to one or more requests for modification from the reader, such as requests to delete a list entry, or requests to modify or replace the translation specified in a list entry. Tables or other presentations can be used instead of, or in addition to, lists.

Step 1114 optionally prepares a text 106. This step (which may itself be viewed as a sequence of steps) might be performed by the same system that displays 902 text and provides incremental translations, or it may be performed on a different system. For example, it may be provided as a separate service through a web site that transforms literary works into a text 106 format that is needed for incremental immersion, after which the resulting texts 106 are downloaded to a user's desktop, laptop, or handheld device 100 for incremental immersion reading.

The service 1114 involves transforming a literary work provided by a user in at least one language (call it language A) to support incremental immersion in a translation of the work. This transformation may be accomplished by the steps of (a) dividing the work into linguistic units, e.g., into individual oriental characters or words; (b) obtaining a translation of those characters or words through, e.g., human translation, dictionary lookup, and/or machine translation into a language B; (c) building a data structure that includes ordering instructions for placing the linguistic units in order to display a copy of the work's cohesive text in language A; and (d) building a data structure that contains selection state information indicating which linguistic units should be displayed in which language, such as an indication that all linguistic units are to be initially displayed in language A or an indication that all linguistic units are to be initially displayed in language B. The steps may be interwoven and/or reordered, e.g., the service process 1114 may initialize an empty table of linguistic units to display in English by default, and then divide the work's first sentence into words, and then loop through those words while assigning each new word to the next entry in the table of linguistic units and appending the word's table entry index to a list that specifies display order.

More About Linguistic Units and Their Translations

The decision as to what is a translation (or if multiple possible translations are displayed 1104, the decision as to what is a possible translation) can be made in different ways to support the translation obtaining step 906. During step 906, systems according to the invention may do a simple language translation dictionary lookup, and display 908 the results. They may use machine translation algorithms 402, like those in use, e.g., at http://babelfish.altavista.com/tr. They may use predefined correspondences, set up by content experts between an English version of a text, for instance, and a French version, and defined in data structures such as those shown in the figures, to reduce or remove the confusion and ambiguity that might otherwise be present due to an ambiguous dictionary lookup result or a mistaken machine translation. Use of predefined correspondences to establish translations may be especially desirable in conjunction with restrictions on which linguistic units are selectable that require a group of words/characters such as a phrase or idiom be selected 904 when any word/character in the group is tapped/clicked on.

In some embodiments, idioms are linguistic units. Their translation is handled using one or more of the display 908, 1104 techniques discussed herein, e.g., with or without flipping back and forth several times to reinforce the correlation between phrases. In some embodiments, idioms are translated first into literal form and then into the other language in nonliteral form. For instance, with the assistance of an idiom dictionary and/or predefined linguistic unit correspondences, the French idiom “nu comme un ver” might be translated to the English idiom “naked as a jay bird” in the following displayed 1104, 908 steps:

nu comme un ver

naked like a worm (lit.)

naked as a jay bird

Translation in the other direction might be shown in the following displayed 1104, 908 steps:

naked as a jay bird

nu comme un jay-oiseau (lit.)

nu comme un ver

More About Animation

As noted, the movement of words/characters can be animated 1104 during the transition between languages. Thus, as a reader translates successive words of the English sentence “Have you read the book?” into German, the display in one embodiment takes the successive appearances shown below. Each sentence overwrites the previous one at the same screen location. Since this patent document is a static document, the successive strings are shown here one below another all at the same time, but they could be displayed dynamically on top of the same location one after another in time:

Have you read the book?

Have you read the Buch?

Have you read das Buch?

Have Sie read das Buch?

Have Sie lasen das Buch?

Haben Sie lasen das Buch?

| | |
|---|---|
| Haben Sie | das Buch lasen? |
| Haben Sie | das Buch lasen? |
| Haben Sie | das Buch lasen? |
| Haben Sie | das Buch lasen? |
| Haben Sie | das Buch lasen? |
| Haben Sie | das Buch gelesen? |

In another embodiment, the displayed text is double-spaced, and the word “lasen” travels 1104 along the normally empty line below the displayed text line, in animated fashion a few pixels at a time, to its new location at the end of the sentence, and the space it left behind closes 1104 in animated fashion to bring “Sie” and “das” next to each other.

The example above also involves changing the conjugation of the German verb “lesen” (English “to read”) from “lasen” into “gelesen”. Regardless of whether a word/character order change is involved, and regardless of how it is shown if involved, activities such as verb conjugation, derivation from a root (e.g., in Arabic), noun declension (e.g., in Icelandic), and gender agreement (e.g., in French or German) can be animated 1104 in a way that shows the reader a range of choices and which choice is being made. For instance, the verb's infinitive could be shown 1104 before the conjugated verb is shown 908. Likewise, instead of transitioning from English “the” in the sentence above directly to German “das”, the display could show 1104 all three possible translations of “the” (“der”, “die”, and “das”) before settling 908 on “das”. A comment elsewhere in the display could point out 1108 to the reader that “Buch” is of neuter gender and that “das” is the neuter article. Likewise, a context-sensitive comment could highlight 1108 important grammatical concepts such as tense or verb regularity.

More generally, mappings between individual words/characters (or other selected text) of the languages are not necessarily one-to-one. Alternate translations could be shown 1104 before the display settles 908 on one automatically or the reader taps/clicks to select one. The possible translations could be shown all at once, or cycled through.

Server Architecture

FIG. 12 illustrates a server-based architecture 1200 embodying the present invention. The server-based architecture 1200 includes one or more servers 1202 and one or more clients 1204; a configuration with two clients 1204 is illustrated. A system of computers including at least one server 1202 and at least one client 1204 according to the invention could be offered, made, or sold as a bundled package. However, different parts of such a system could also be provided by different vendors, with various inventive services offered through the assembled system. For instance, different configurations of one or more servers 1202 could provide one or more of the following services: preparing 1114 texts 106 (as noted, such a service could also be provided in a device or system which does not necessarily have network connectivity); tracking 910 user translation preferences in work-independent structures; preloading 1102 user translation preferences; providing incremental immersion to readers via repeated cycles involving steps 902/1002, 904/1004, 906, 908/1006, 910/1008, 912/1010 (note that not every step will necessarily be repeated in each cycle, e.g., several display steps 902/1002 may be performed before a translation is requested 904/1004).

As illustrated, each client 1204 includes storage 1206 such as RAM, ROM, EPROM, flash memory, magnetic disks, magneto-optical disks, CD-ROM, DVD, and/or other computer readable storage. The storage 1206 may be configured by virtue of holding a text 106 formatted for incremental immersion. The storage 1206 may be configured by virtue of holding tree, table, list, string, or other data structures for incremental immersion such as those discussed herein and/or shown in FIGS. 5-8, 13-16. The storage 1206 may be configured by virtue of holding program code for performing any or all of the services noted in the preceding paragraph.

As illustrated, each client 1204 includes a processing component 1208 and the server 1202 also includes a processing component 1210. Processing components are shown at each location to emphasize that the functionality required to provide the inventive services may be divided between servers 1202 and clients 1204 in various ways, with most of the processing done at the server in some configurations, most of it done at the client in some configurations, and the processing split more evenly between the two in yet other configurations. In some embodiments, the processing in architecture 1200 performs the functions performed by components 204, 208. In some, the processing components 1208 and/or 1210 provide services illustrated in FIGS. 9 and/or 11.

The server(s) 1202 ands client(s) 1204 communicate with each other via connectivity components 1212. Connectivity may be provided using familiar means, for wired and/or wireless connections, over phone lines, microwave, optical links, and other transmission media, using serial, TCP/IP, routing, and/or other protocols, with or without intervening networks (e.g., over the Internet) in the various embodiments.

Each user 1214 may have a dedicated personal client 1204, or clients may be shared by more than one user. In one embodiment, the server 1202 serves multiple users 1214, so it contains login and accounting features 1216 to distinguish between users and make sure each user is billed correctly for the services provided. Familiar user authentication and registration tools and techniques may be employed, such as passwords and digital certificates. Each registered user's individual translation preferences 302 can be maintained within a larger database of registered user preferences, on a per-user basis.

Some embodiments contain an online library 1218 of texts 106 which are available to registered users and/or as free demonstrations available to the public at large. Individual user libraries may also be maintained. Access to texts 106 may be restricted according to various license arrangements. A text 106 might be available for downloading to permanent storage outside the server 1202, for example, or it may be restricted to temporary downloading for reading at a client 1204 only while a user is logged in.

More About Data Structures

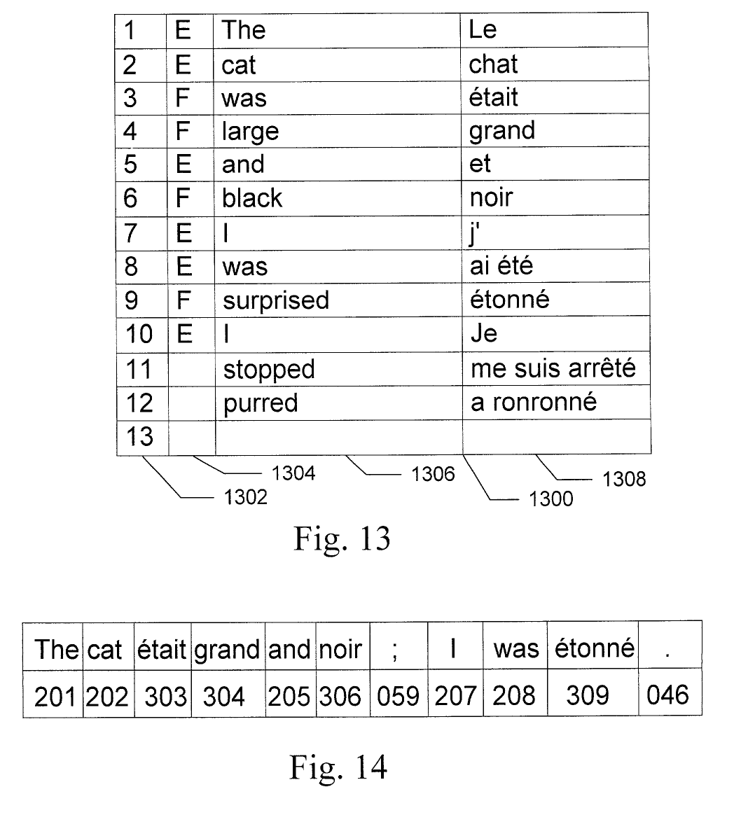

In addition to the discussion elsewhere of data structures and pieces of information used according to the invention, the following may be noted about the particular examples shown in FIGS. 13-16. FIGS. 13 and 14 together show data structures that comprise a table 1300 of linguistic terms (FIG. 13) and an ordered sequence of term identifiers (FIG. 14 bottom row) with corresponding displayed strings (FIG. 14 top row). Other data structures may also be used to help implement the invention. Text strings or bitmaps and meta-data regarding the text may be stored in HTML, XML, PDF, RTF, ASCII, and other formats, in conjunction with proprietary data formats or standard data formats such as the Open eBook Publication Structure, which are adapted or supplemented to provide the functionality called for by the present invention.

With regard to FIG. 13, column 1302 of the table 1300 of linguistic units contains indices into the table 1300. This column is shown for convenience; like array indices, column 1302 need not be actually stored in memory. The table 1300 could also be indexed beginning at zero or some other number, rather than one. Column 1304 contains display preference state information; in the illustrated example, an “E” indicates the linguistic unit in that row should be displayed in English, and an “F” indicates it should be displayed in French. Thus, in the top row of FIG. 14, “The” is displayed instead of “Le”, and “noir” is displayed instead of “black”, for example. Column 1306 and column 1308 contain the English and French counterpart translations, respectively, for the linguistic units in the table 1300. For ease of illustration, the English and French counterparts are shown in the same row, and they could be stored that way in memory. However, they could also be stored in other ways, such as in a single column with all the English terms followed by all the French terms or in separate tables.

With regard to FIG. 14, the top row shows text that would be displayed on a device 210 given the illustrated content of the table 1300. The bottom row shows a sequence of numbers that can be used to generate that text display. The sequence illustrated includes both linguistic unit ordering information and translation preference information. Within a given sequence number, the linguistic unit's identity is indicated by an index into the table 1300, and its translation preference is indicated by an offset. In the example an offset of zero means the unit is punctuation that is displayed the same way in either language, an offset of 200 means the linguistic unit should be displayed in English, and an offset of 300 means the linguistic unit should be displayed in French. Thus, sequence value 201 has a table index of 1 and an offset of 200, so it corresponds to text “The”. Sequence value 301 would correspond to text “Le”. Similarly, sequence value 202 corresponds to “cat”; value 302 would correspond to “chat”.

In the illustrated example, some punctuation is represented by its ASCII value, so no table lookup is needed for offsets under 200. The sequence value is the ASCII value of the ASCII character to be displayed. Of course, other punctuation might have a table 1300 entry, e.g., double quotes and angle brackets are counterparts in English and French, respectively.

The display can thus be generated from the sequence values by looping through the sequence values in order and displaying for each value V: the ASCII character having that value V, if V is below 200; the English entry at index ix=V-200 into table 1300 if V is between 200 and 299; and the French entry at index ix=V-300 into table 1300 if V is 300 or larger. Of course, different offsets can also be used, and probably would be used in practice because the example assumes a maximum of one hundred linguistic units in the text 106. Likewise, with some modification more than two languages could be used.

Alternately, the sequence of values could include only the indices, in display order; no offsets would be embedded in the sequence to specify language selections. Instead, the language in which to display an indexed linguistic unit would be determined by checking column 1304 for that unit's index value. Table 1300 would have entries for punctuation, to avoid confusing a table index with an ASCII character value. Other combinations of linguistic unit ordering sequence data structures with one or more tables of linguistic unit text or bitmap values may also be used to implement the invention. Implementations without tables can also be used.

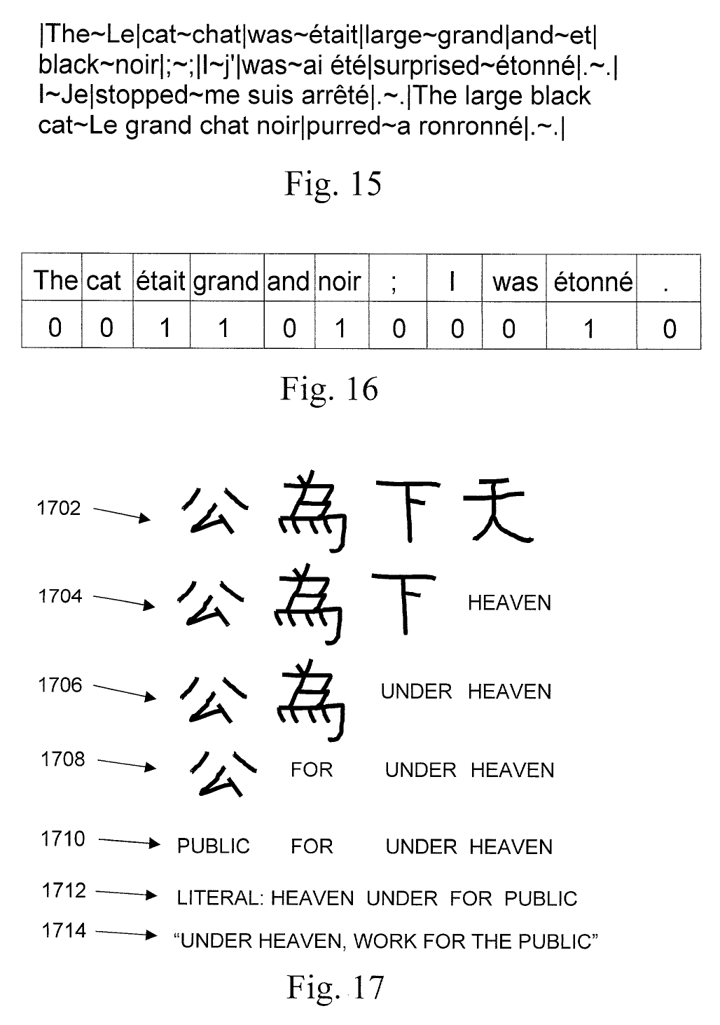

FIGS. 15 and 16 together show data structures that comprise a formatted string (FIG. 15) and an ordered sequence of display state values (FIG. 16 bottom row) with corresponding displayed strings (FIG. 16 top row). Other data structures may also be used to help implement the invention. In this implementation, the formatted string provides the division of text into linguistic units; linguistic units are separated by vertical bars |, and counterparts in different languages are separated by tildes ˜. The formatted string in FIG. 15 also provides the necessary information for ordering linguistic units to display a cohesive text. Translation preferences are not encoded in the formatted string, but are recorded instead in a bitstring. The bitstring shown has only one bit per linguistic unit, since only two languages are involved, but additional bits per linguistic unit could be used in other embodiments to support more than two languages. In the bitstring (bottom row of FIG. 16), a zero indicates the corresponding linguistic unit should be displayed in English and a one indicates the linguistic unit should be displayed in French.

Incremental Immersion with Three or More Languages at a Time

Although the examples above focus on translation between two languages, some embodiments translate at a given time between three or more languages and/or between three or more language notations. For instance, one device 100 may permit the reader to incrementally translate an English text into both French and German, alternating between the two destination languages as the reader sees fit, with a multi-line display per source language sentence as illustrated below. In this example, each subsequent set of lines overwrites 902, 908, 912 the preceding set on the display. That is, the sequence in space shown here is implemented as a sequence in time in the system or device. For clarity, the most recently translated linguistic unit SB is underlined in each display snapshot:

The cat was large and black.

The cat was large and black.

The cat was large and black.

Die Katze was large and black.

Le chat was large and black.

Die Katze was large and black.

Le chat was grand and black.

Die Katze was large and black.

Le chat was grand and black.

Die Katze was groβ and black.

Le chat was grand et black.

Die Katze was groβ and black.

Le chat was grand et noir.

Die Katze was groβ and black.

Le chat was grand et noir.

Die Katze was groβ und black.

Le chat was grand et noir.

Die Katze was groβ und schwarz.

Le chat was grand et noir.

Die Katze war groβ und schwarz.

Le chat était grand et noir.

Die Katze war groβ und schwarz.

Some embodiments display 902, 908, 912 multiple language notations, e.g., English as a source language, and a combination as a destination language, with the combination including Chinese characters and their respective notations in Pinyin, Yale, and/or other systems. Chinese and other languages may present pronunciation hints or guides in a phonetic notation. Regardless of whether multiple notations are employed, some embodiments that use as a destination language Chinese (or another character-based language in which stroke order is important) animate 1104 the drawing of the character to show the stroke order as the character is drawn during the transition between languages.

### Another Example

FIG. 17 illustrates some of the points made above, using an example 1700 in which a text 106 of Chinese characters is incrementally translated into English. The text in line 1702 is a saying of the Chinese sage Confucius, which urges people to work together for the good of all concerned. In a preferred embodiment, the characters are overwritten in place so that each successive line 1704 through 1714 appears at the same location on the display 210 as the previous line; in other embodiments, Chinese and English are displayed simultaneously even after a translation is accepted. Four characters are initially displayed, as shown in line 1702. Then the rightmost character is selected by the reader and so replaced by the word “HEAVEN”, as shown in line 1704. Next, the rightmost remaining character is selected and replaced by the word “UNDER” as shown in line 1706, and so on. Of course, a reader might also select 1004 characters for translation in a different order than that illustrated in FIG. 17. Characters can be represented by bitmaps, Unicode, Universal Character Set, or other encodings. The calligraphy shown here was done by the inventor; more skillful calligraphers can be employed in preparing commercial embodiments of the invention. Translation from English to characters may include animation 1104 to show character strokes in order as they are drawn to make the character. Animation 1104 of the translation may also or alternately include changing the order of translated linguistic units, as occurs between lines 1710 and 1712. Animation 1104 of the translation may also or alternately include transitioning from a literal translation such as in line 1712 to a looser but perhaps more accurate translation as in line 1714. Different English translations may also be used.

Conclusion

In short, the inventive system can not only display translated portions of text, it can also keep track of which translations have been requested by the reader, and their degree of success (permanence), and it can use that tracking information to display translated/untranslated text accordingly. A reader can reset some or all translations back to another language, and the display changes again accordingly.

The present invention also includes methods for performing the actions described here, which may use inventive device(s) such as desktop, laptop, or handheld computers that perform the steps discussed herein. Software embodying the invention might be provided by authorized parties in the form of retail packages and/or may be run on a server to provide a subscription service of incremental personalized reader-guided translation on a network, for instance. Embodiments such as the systems or methods illustrated may omit items/steps, repeat items/steps, group them differently, supplement them with familiar items/steps, or otherwise comprise variations on the given examples.

Suitable software to assist in implementing the invention is readily provided by those of skill in the pertinent art(s) using the teachings presented here and programming languages and tools such as C++, C, Java, Pascal, APIs, SDKs, assembly, firmware, microcode, and/or other languages and tools.

Although particular embodiments of the present invention are expressly illustrated and described individually herein, it will be appreciated that discussion of one type of embodiment also generally extends to other embodiment types. For instance, the description of the methods illustrated in FIGS. 9-11 also helps describe the systems in FIGS. 1-4, 12, and vice versa. Likewise, the description of data structures in FIGS. 5-8, 13-16 also helps describe algorithms for creating, manipulating, displaying text from, modifying, and freeing such data structures. Moreover, the incremental translation results displayed in FIGS. 1, 7, 8, 14, 16, and 17 help define and thus describe the various devices, systems, methods, data structures, and algorithms that may be provided or used according to the invention, both in conjunction with and apart from the specific examples detailed herein. All claims as filed are part of the specification and thus help describe the invention, and repeated claim language may be inserted outside the claims as needed.

As used herein, terms such as “a” and “the” and designations such as “displaying”, “data structure”, and “language”, are inclusive of one or more of the indicated item or step. In particular, in the claims a reference to an item generally means at least one such item is present and a reference to a step means at least one instance of the step is performed.

The invention may be embodied in other specific forms without departing from its essential characteristics. The described embodiments are to be considered in all respects only as illustrative and not restrictive. Headings are for convenience only. The scope of the invention is, therefore, indicated by the appended claims rather than by the foregoing description. All changes which come within the meaning and range of equivalency of the claims are to be embraced within their scope to the full extent permitted by law.

What is claimed and desired to be secured by patent is:

1. A method for use in a system to incrementally immerse a reader in a translation as the reader traverses a cohesive text, the method comprising the steps of:
displaying on a display device a displayed text portion which is at least a portion of the cohesive text, the displayed text portion being at least partially in a first language;
receiving a selection of a selected text which is at least part of the displayed text portion, the selection being made by the reader as a request for translation of the selected text, the selected text belonging to a linguistic unit;
obtaining in response to the selection a counterpart text of the specified linguistic unit, the counterpart text being at least partially in a second language, the counterpart text being a translation of the selected text;
displaying the counterpart text on the display device;
noting in a data structure a preference of the reader for display of the counterpart text; and
subsequently displaying the counterpart text, without requiring a further request from the reader for translation of the selected text into the counterpart text, when another instance of the linguistic unit is encountered during the reader's traversal of the cohesive text.

2. The method of claim 1, wherein the step of displaying the counterpart text replaces the selected text with the counterpart text on the display device.

3. The method of claim 1, preceded by the step of preloading into a memory state information specifying preferences for displaying particular linguistic units in particular languages.

4. The method of claim 1, further comprising the step of speaking the counterpart text in conjunction with displaying it.

5. The method of claim 1, further comprising the step of displaying a comment about the selected text, about the counterpart text, or about both, in conjunction with displaying the counterpart text.

6. The method of claim 1, further comprising the step of displaying to the reader a list of accepted translations, in which translation of the selected text into the counterpart text is among the accepted translations.

7. The method of claim 6, further comprising the step of modifying the list of accepted translations in response to an editing request from the reader.

8. The method of claim 1, wherein the step of displaying the counterpart text is preceded by displaying an animation of translation between the selected text and the counterpart text.

9. The method of claim 8, wherein the animation comprises animation illustrating differences in sentence order between two languages.

10. The method of claim 8, wherein the animation comprises animation illustrating character stroke order.

11. The method of claim 1, wherein the displaying step displays a displayed text portion in at least three languages and instances of the noting step note preferences for display in each of at least three languages.

12. The method of claim 1, wherein each of the first language and the second language is a natural language.

13. The method of claim 1, wherein at least one of the first language and the second language is an artificial language.

14. The method of claim 1, wherein the obtaining step performs at least one of the following to obtain the counterpart text: a lookup in a table of linguistic units, a lookup in a dictionary which is useable apart from the method, an on-the-fly translation by a machine translation service which is useable apart from the method.

15. The method of claim 1, wherein the step of receiving a selection receives selection of at least one of the following as the selected text: a single word, a single character, a phrase, an idiom, a combined noun and article.

16. A method for use by a reader to be incrementally immersed in a translation as the reader traverses a cohesive text, the method comprising the steps of:
viewing on a display driven by a processor a displayed text portion which is at least a portion of the cohesive text, the displayed text portion being at least partially in a first language;
selecting a selected text which is at least part of the displayed text portion, the selection being made as a request for translation of the selected text;
viewing a counterpart text on the display, the counterpart text being at least partially in a second language, the counterpart text being a translation of the selected text;
indicating a preference for display of the counterpart text; and
subsequently viewing the counterpart text, without making a further request for translation of the selected text into the counterpart text, when another instance of the selected text would have been encountered during traversal of the cohesive text absent the selecting step.

17. The method of claim 16, preceded by the step of preloading into a memory state information specifying preferences for displaying particular linguistic units in particular languages.

18. The method of claim 16, further comprising the step of viewing a list of accepted natural language translations.

19. The method of claim 16, wherein the step of viewing the counterpart text is preceded by viewing an animation of translation of the selected text.

20. The method of claim 16, preceded by the step of preparing the cohesive text by submitting a copy of text in a first language to a computer for transformation by the computer into a format supporting incremental immersion during the preceded steps.

21. A computer-implemented method for transforming a literary work provided by a user in at least a first language to support incremental immersion in a translation of the work, the method comprising the steps of:
dividing the work into linguistic units, each linguistic unit having a text in the first language;
obtaining translation of the first language text of the linguistic units into a second language;
building in a data structure ordering instructions for placing the linguistic units in order to display a copy of the work as cohesive text in the first language;
building in the same or another data structure selection state information indicating which linguistic units should be displayed in which language.

22. A configured computer-readable storage medium which will cause at least a portion of a computer system to perform method steps for incrementally immersing a reader in a translation as the reader traverses a cohesive text, the method comprising the steps of claim 1.

23. The configured computer-readable storage medium of claim 22, wherein the method comprises the steps of claim 2.

24. The configured computer-readable storage medium of claim 22, wherein the method comprises the steps of claim 3.

25. The configured computer-readable storage medium of claim 22, wherein the method comprises the steps of claim 8.

26. The configured computer-readable storage medium of claim 22, wherein the method comprises the steps of claim 10.

27. The configured computer-readable storage medium of claim 22, wherein the method comprises the steps of claim 11.

28. The configured computer-readable storage medium of claim 22, wherein the method comprises the steps of claim 12.

29. A configured computer-readable storage medium which will cause at least a portion of a computer system to perform method steps for transforming a literary work provided by a user in at least a first language to support incremental immersion in a translation of the work, the method comprising the steps of claim 16.

30. A system for reader-guided incremental immersion in a natural language translation, comprising:
a selection input device;
a display output device;
textual units from a cohesive text;
selection state information indicating a natural language preference for display of the textual units; and
at least one processing component which receives from the selection input device a selection of text that is displayed on the display output device, which changes the selection state information to indicate a different natural language preference for display of the selected text, and which sends the translation to the display output device to be displayed in a partial translation of the cohesive text;
wherein the translation is subsequently displayed in conjunction with another instance of the selected text as a result of the change in the selection state information and without requiring any further request through the selection input device for translation of the selected text.

31. The system of claim 30, wherein the processing component comprises software configuring at least one of: a handheld computer, a client computer in a computer network.

32. The system of claim 30, wherein the selection input device comprises at least one of: a touch screen, a screen in combination with a pointing device.

33. The system of claim 30, wherein the processing component comprises at least one of:
a tree data structure containing selected text, translations thereof, implicit order information for displaying text, and selection state information;
a table data structure containing selected text, translations thereof, and selection state information, in combination with another data structure containing order information for displaying text;
a first data structure containing selected text and translations thereof, in combination with at least one other data structure which contain(s) order information for displaying text and selection state information.

34. The system of claim 30, further comprising comments which are displayed in conjunction with the selection of text.

35. The system of claim 30, wherein the system comprises at least one server and at least one client connected via connectivity components.

36. The system of claim 30, further comprising a component which transforms a literary work into a format that supports incremental immersion in a translation of the work.

37. The system of claim 30, wherein the processing component also preloads selection state information into a system memory, thereby specifying preferences for displaying particular texts in particular natural languages.

38. The system of claim 30, wherein the processing component also animates on the display a transition between text translations.

39. The system of claim 30, wherein the translation is subsequently displayed in conjunction with another instance of the selected text by at least one of: being subsequently displayed in place of the selected text, being subsequently displayed with the selected text.

40. A system for reader-guided incremental immersion in a translation, comprising:
a selection input device;
a display output device; and
at least one computer-readable memory configured by (a) a collection of linguistic units in a given language and counterparts in at least one other language; (b) ordering instructions for placing instances of the linguistic units in order to provide a cohesive text that is displayed on the display output device; and (c) selection state information received at least in part through the selection input device, the selection state information indicating which linguistic units should be displayed in which language on the display output device.

41. A method for use in a system to incrementally immerse a reader in a translation between different subsets of a single natural language as the reader traverses a cohesive text, the method comprising the steps of:
displaying on a display device a displayed text portion which is at least a portion of the cohesive text, the displayed text portion being at least partially in a first predefined subset of a natural language;
receiving a selection of a selected text which is at least part of the displayed text portion, the selection being made by the reader as a request for translation of the selected text, the selected text belonging to a linguistic unit;
obtaining in response to the selection a counterpart text of the specified linguistic unit, the counterpart text being at least partially in a second predefined subset of the natural language, the counterpart text being a translation of the selected text;
displaying the counterpart text on the display device;
noting in a data structure a preference of the reader for display of the counterpart text; and
subsequently displaying the counterpart text, without requiring a further request from the reader for translation of the selected text into the counterpart text, when another instance of the linguistic unit is encountered during the reader's traversal of the cohesive text.

42. The method of claim 1, wherein the subsets of the natural language are predefined according to difficulty.

43. The method of claim 1, wherein the subsets of the natural language are predefined according to their jargon content.
